(19) United States
(12) Patent Application Publication
(10) Pub. No.: US 2021/0215268 A1
(43) Pub. Date: Jul. 15, 2021

(54) QUICK ACTING VALVE AND ACTUATOR

(71) Applicant: Glenn Fernandes, Thane (IN)

(72) Inventor: Glenn Fernandes, Thane (IN)

(21) Appl. No.: 16/652,273

(22) PCT Filed: Oct. 1, 2018
(86) PCT No.: PCT/IN2018/050626

§ 371 Date: Mar. 30, 2020

(51) Int. Cl. F16K 31/08

(52) U.S. Cl. CPC F16K 31/082; F16K 31/084; F16K 31/088

(57) ABSTRACT

Ultra-high speed valve comprising a valve unit which comprises: a moving valve member, a valve seat and a magnetic latch, such that the valve is held shut by the latch, holding the moving valve member against the valve seat such that the valve bursts open along the direction of fluid flow the moment the valve is unlatched, aided by the fluid pressure. The valve opening can be additionally aided by decompression of a compression member compressed by the latched moving valve member and by using an additional actuator connected to the moving valve member. Movement of the moving valve member can also be accelerated by utilizing varying fluid pressures on both sides of the moving valve member. Combinations of the valve unit can be used to configure monostable and bistable valves and to form ultra-high speed actuators when used with compressed air.

### CROSS-REFERENCE TO RELATED APPLICATIONS

This application claims the benefit of PCT Application No. PCT/IN2018/050626 filed on 1 Oct. 2018.

### FIELD OF INVENTION

Embodiments of the present invention relate to the field of valves, more particularly, to the field of ultra-high speed fluidic valves and actuation means, which are also very low cost, very lightweight and run on very low power.

### BACKGROUND OF INVENTION

Fluidic valves are mainly of two types—spool type and poppet type. Each has certain drawbacks. Spool-type is frictional and thus has a limited lifespan, is prone to leakage, needs high actuation power and requires lubrication. It is not suitable where the medium needs to be clean. Poppet types have a complicated construction and require more power to operate. These valves are actuated mechanically, or by solenoids, or by air. Solenoids are large, expensive, and require huge power; mechanical actuation is slow, and air actuation is not suitable for high-pressure hydraulics.

The fastest fluidic valves today still operate in the millisecond range. There is a need for fluidic valves that are extremely high speed, low cost, low weight, long lasting, with a simple construction and without the need for lubrication.

Thus, the present invention describes a novel fluidic valve and actuation system that is simple to construct, compact, low weight, low power, long life, with no problems of friction/leakage/lubrication and permits ultrafast actuation in the microsecond range. Fast switching valves decrease switching times, shorten cycle times, and increase productivity. Implications of these valves are huge in the field of pneumatics and hydraulics, especially in the field of medical lifesaving equipment, control systems, and dosing and sorting in industries, textiles industries, etc.

### SUMMARY OF INVENTION

Embodiments of the present invention are directed to ultra-high speed fluidic valves and actuators that burst open along the direction of fluid flow comprising: a valve unit which comprises a moving valve member to open and shut the valve; a valve seat; and a latch such that the valve is held shut against the direction of fluid flow by the latch which holds the moving valve member abutting against the valve seat such that the moment the moving valve member is unlatched, the valve bursts open with forward movement of the moving valve member along the direction of fluid flow.

Preferably, embodiments may also comprise additionally, a compression member to absorb the shock from the movement of the moving valve member and also to aid in the forward movement of the moving valve member when unlatched. More preferably, certain embodiments may also have an additional actuator connected to the moving valve member, to further aid in its movement. The additional actuators, in some embodiments, may have electronic circuitry comprising a means to produce high voltage pulse, to instantly unlatch the valve, and power the actuator exponentially to move the moving valve member forward, the subsequent fly-back of which may power the latch which may latch the moving valve member, stopping its movement backward.

It is also contemplated to have one or more valve units combined to form monostable/bistable valves of different configurations. Preferably, the latch is magnetic, and may have various combinations of permanent and/or electromagnets, for ultrafast actuation. It is also contemplated to utilize a varying fluid pressure on two sides of the moving valve member to help in quick opening of the valve.

It is also contemplated to make an ultrafast actuator utilizing a compressed air source and any/all of the valve actuation means of this invention.

The principal object of the invention is to provide a fluidic valve with an ultra-high speed movement, having an extremely short response time in the microsecond range.

Another object of the invention is to provide a bistable fluidic valve with an ultra-high speed movement, having an extremely short response time in the microsecond range.

Another object of the invention is to utilize varying fluid pressures on both sides of a moving valve member to aid in ultra-high speed actuation of the valve.

Another object of the invention is to provide an ultra-high speed linear actuator.

Another object of the invention is to provide additional active actuation to aid in ultra-high speed opening of the valve.

Another object of the invention is to provide a high frequency vibratory or oscillatory device.

Another object of the invention is to provide an ultra-high speed rotary fluidic valve.

While the invention is described herein by way of example using several embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modification, equivalents, and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Various objects, features, aspects, and advantages of the present invention will become more apparent from the following detailed description of preferred embodiments of the invention, along with the accompanying drawings in which like numerals represent like components

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figures, with like reference numbers referring to like structures across the views, wherein:

FIG. 1A and FIG. 1B illustrate cross-sectional views of one embodiment of the fluidic valve of the current invention, operating using differential fluidic pressures in addition to magnetic latches.

FIG. 2A and FIG. 2B illustrate cross-sectional views of yet another embodiment of the fluidic valve and actuator of the current invention, operating using differential fluidic pressures in addition to magnetic latches

FIG. 3A, 3B, 3C, 3D, illustrate different perspective views of a one-way fluidic valve according to one embodiment of the present invention, operating using magnetic latches.

FIGS. 3E, 3F and 3G illustrate different schematic views of the one-way fluidic valve according to the embodiment shown in FIGS. 3A, 3B, 3C and 3D of the present invention, operating using magnetic latches.

FIGS. 4A and 4B illustrate a cross-section view and perspective view respectively, of the fluidic valve according to one embodiment of the present invention, using two sets of magnetic latches for each moving valve member.

FIG. 4C illustrates a perspective view of a moving valve member according to one embodiment of the present invention

FIG. 5 illustrates a cross-section view of another embodiment of the present invention, with is a 4/2 type of fluidic valve with the rotary movement of valve members to open and close the valve.

FIG. 6 illustrates a circuit diagram of one embodiment of the present invention, which helps in ultra-fast actuation of the valve.

FIG. 7 illustrates a top view of one embodiment of the present invention with additional coil and permanent magnet on moving valve members of the valve.

### DETAILED DESCRIPTION OF THE INVENTION

Embodiments of the present invention are directed to ultra-high speed fluidic valves and actuators that require no lubrication, are frictionless and require minimal energy to operate them.

The valves operated along fluid pressure, and are thus different from conventional poppet valves, which all open against the fluid pressure; which require huge amounts of energy, and also results in a delay in the valve opening it. The valves described in this invention, contrary to normal logic, open along the direction of the fluid flow. This gives them the advantage of ultra-high speed of opening, within microseconds, since they burst open, aided by the fluid pressure, along with the direction of the fluid flow.

The valves can be actuated by operating a latch. In certain embodiments, the valve comprises a moving valve member to open and shut the valve, a valve seat, a compression member; and a latch. The valve is held shut against the direction of fluid flow by the moving valve member abutting against the valve seat while simultaneously compressing the compression member by the latch, such that the moment the valve is unlatched, the compressed compression member decompresses, and pushing the moving valve member that was compressing against it forward, bursting the valve open along the direction of fluid flow. Compression members may be made of rubber and may also serve to seal the valve

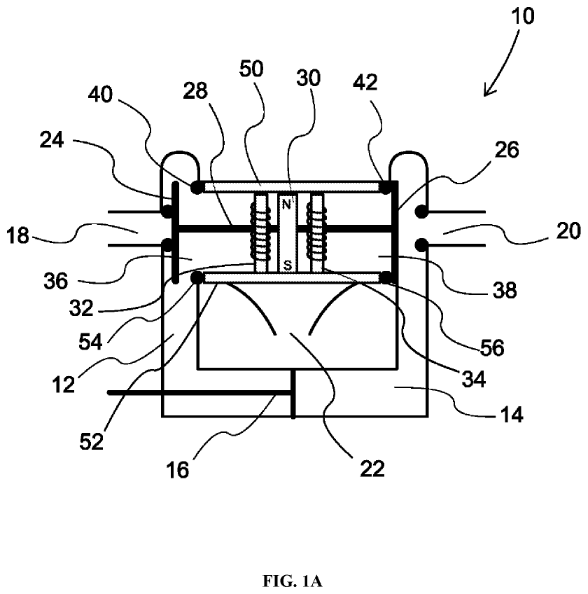

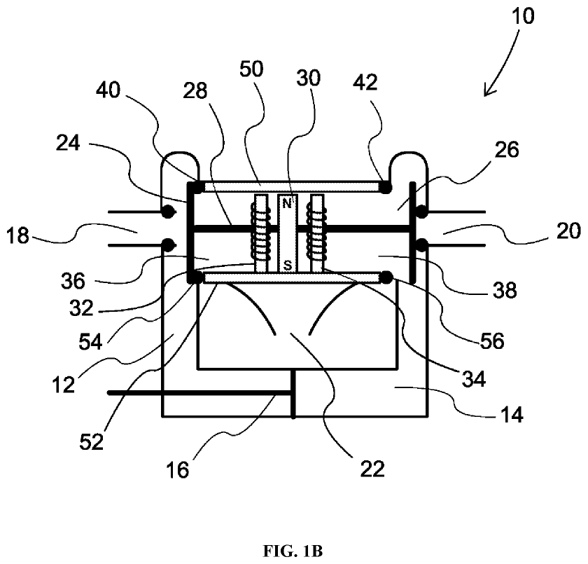

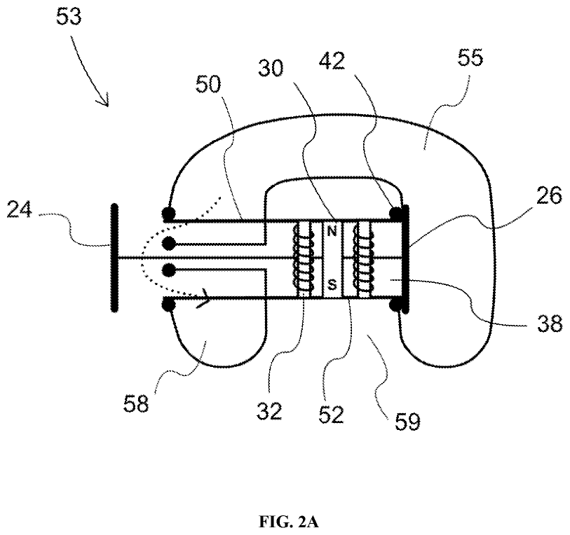

One embodiment of the valve mechanism 10 disclosed in this invention, is given in FIG. 1A to illustrate the working of the fluidic valve of this invention.

In this embodiment, the fluidic valve is actuated by fluidic means, such as pneumatic or hydraulic, with additional support from magnet-based latches. The differential pressures between the controlling fluids are harnessed to actuate the valve, with minimal energy input. The magnet-based latches utilize a high permeability magnetic path to hold the moving valve member closed against the pressure flow, along with another magnetic path formed by an electromagnet with low magnetic permeability, to divert magnetic flux lines away from the earlier high permeability magnetic path, allowing for the ultrafast release of the valve, along with the direction of fluid pressure and flow.

The fluidic valve of this embodiment comprises two ports 12 and 14 on two sides of a piston 16; two vacuum ports 18 and 20 leading to two sources of vacuum; port 22 leads to a compressed air chamber; moving valve members 24 and 26 which are made of magnetic material with high magnetic permeability; central guide rod 28 that connects the two moving valve members, and moves within the valve housing; permanent magnet 30; two low permeability electromagnets 32 and 34 that divert the magnetic path of flux lines from permanent magnet 30 through either moving valve member 24 or 26 to the opposite side respectively, via high magnetic permeability paths 50 and 52. The valve being closable at valve seats 40 and 42, against compression members 54 present at both valve seats 40 and 42. So this embodiment is a 5/2 valve, with 5 ports and 2 positions.

The valve at opening 36 is open and it closes vacuum port 18, and the compressed air is exhausted through port 12, to push the piston 16 to the right. The exhaust from the right side of the piston 16 is vented out through port 14 to vacuum port 20. Meanwhile, the moving valve member 26 is being held pressed against the compression member 54 of valve seat 42, by magnetic flux lines from permanent magnet 30, whose magnetic path closes through the moving valve member 26. This moving valve member 26 is being held by the permanent magnet 30, against the compressed air from port 22. To open the valve at opening 38 by moving valve member 26, a short high power pulse is given to low permeability electromagnet 32, which momentarily diverts the magnetic flux lines away from permanent magnet 30 to the moving valve member 26 towards itself, creating a magnetic path between itself and the permanent magnet 30. With no more magnetism to hold the moving valve member 26 to valve seat 42, the moving valve member 26 is instantly pushed out to close vacuum port 20, along the direction of the pressure of compressed air from port 22. This opens the valve at opening 38, almost instantaneously, within a few microseconds, allowing the flow of compressed air from port 22 to port 14, pushing the piston 16 to the left. Moving valve member 24 has meanwhile been pulled towards valve seat 40 by movement of moving valve member 26. As moving valve member 24 comes close to valve seat 40, the magnetic flux lines are diverted from between permanent magnet 30 and low permeability electromagnet 32 and chose instead to flow through permanent magnet 30 to high magnetic permeability moving valve member 24, thus holding moving valve member 24 pressing against compression member 54 of valve seat 40 against compressed air flow from port 22. This opens up vacuum port 18, allowing for exhaust of air from port 12 out through vacuum port 18, into the vacuum source. To open the valve at opening 36, a short high power pulse is now given to electromagnet 34, which diverts the flux lines away from the moving valve member 24 and permanent magnet 30, to flow now between permanent magnet 30 and itself. Thus, compressed air from port 22 opens the valve at opening 36, pulling along with the moving valve member 26, which now approaches valve seat 42, and flux lines leave path from permanent magnet 30 and low permeability electromagnet 34—and flow instead between permanent magnet 30 and high magnetic permeability moving valve member 26, shutting valve at position 38.

An important feature in this embodiment is the differential size of the valve seat and vacuum port. Vacuum ports 18 and 20 are smaller in size than valve seats 40 and 42. This allows vacuum from vacuum port 20 to pull stronger than vacuum from vacuum port 18 in valve position given in FIG. 1A, aiding the compressed air 22, which also finds it easier to push open the valve at opening 38 instead of at opening 36, as soon as the permanent magnet 30 lets go of the moving valve member 26.

In another embodiment, the moving valve members may additionally be actuated using an actuating means like a solenoid, voice coil or moving magnet, to further actively aid the bursting open of the valve along the direction of fluid flow.

Similarly, in FIG. 1B, the vacuum at port 20 has to pull against a smaller surface area of the moving valve member 26, as against vacuum at port 18, which pulls against a larger surface area moving valve member 24, thus vacuum at vacuum port 18 finds it easier to aid the compressed air from port 22 to push the opening 36 open, as soon as the permanent magnet 30 releases the moving valve member 24. High magnetic permeability paths 50 and 52 again conduct the magnetic flux lines through either moving valve member 24 or 26. This illustrates how the fluidics along with the magnetic latches control the valves at inner valve seats 40 and 42.

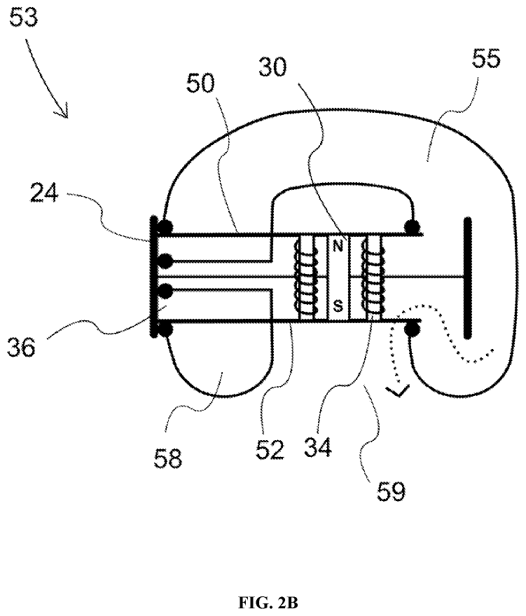

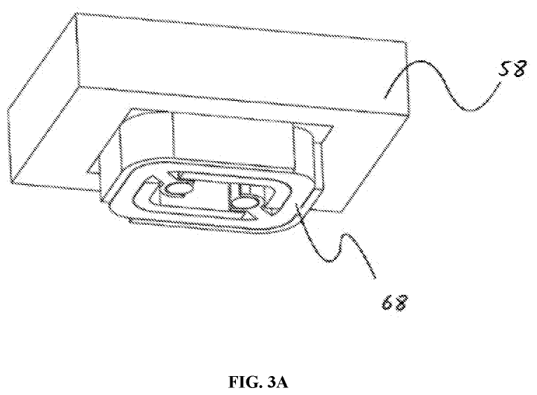

Another embodiment of the present invention, given in FIGS. 2A and 2B, illustrate a use of the valve and actuation means of this invention to alternately open a compressed air chamber and vacuum chamber into a common chamber, again with the aid of magnetic latches.

FIG. 2A shows the valve mechanism 53 in position 1, wherein the common chamber 55 connects with the vacuum chamber 58, while the compressed air chamber 59 is disconnected from the common chamber 55. FIG. 2B shows the valve in position 2, where the common chamber 55 is connected to the compressed air chamber 59, and disconnected from the vacuum chamber 58. High permeability magnetic paths 50 and 52 again conduct the magnetic flux lines through either moving valve member 24 or 26.

In FIG. 2A, i.e. position 1, the moving valve member 26 is held closed against valve seat 42, by magnetic flux lines following the path between permanent magnet 30 and moving valve member 26. To move the valve from position 1 to position 2, a short pulse is given to low magnetic permeability electromagnet 32, which diverts the flux lines towards itself, allowing the compressed air from chamber 59 to burst open the valve at opening 38 within microseconds. High magnetic permeability paths 50 and 52 again conduct the magnetic flux lines through either moving valve member 24 or 26.

Similarly, in FIG. 2B, in order to move the valve from position 2 to position 1, a short magnetic pulse is given to low magnetic permeability electromagnet 34, this diverts the magnetic flux away from the path between permanent magnet 30 and moving valve member 24, to itself, allowing the vacuum to pull the pull the moving valve member 24 towards itself, again almost instantaneously opening valve at opening 36. High magnetic permeability paths 50 and 52 again conduct the magnetic flux lines through either moving valve member 24 or 26.

It is pertinent to note that in both the above embodiments, the same results may be obtained even if there is only one electromagnet in addition to the permanent magnet 30. The main function of the electromagnet would be to divert the flux lines from either path between permanent magnet 30 and the moving valve member 24 or from the path between permanent magnet 30 and the moving valve member 26 to run between itself and the permanent magnet 30 instead, thus releasing the moving valve member 24 or 26 respectively.

The permanent magnet 30 is further long-lasting, as it always has a keeper to it. The actuator is thus not only extremely light-weight and low-energy consuming compared to regular solenoid actuators, but also long-lasting.

The above 2 embodiments are mere illustrations of the various embodiments and applications of the valve and actuating means of this invention. The same operating principles of this invention can be utilized to provide other valve configurations and actuating means for both hydraulic and pneumatic systems.

The aforementioned valve and actuating means can also be utilized in fields other than hydraulics and pneumatics, like in the electrical field for ultrafast opening and closing an electrical circuit, or as a high-speed switch or in the mechanical field for rapidly opening or closing a latch, or as an electromechanical oscillator or actuator

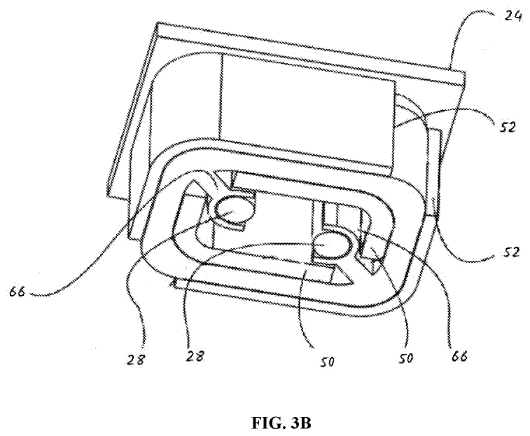

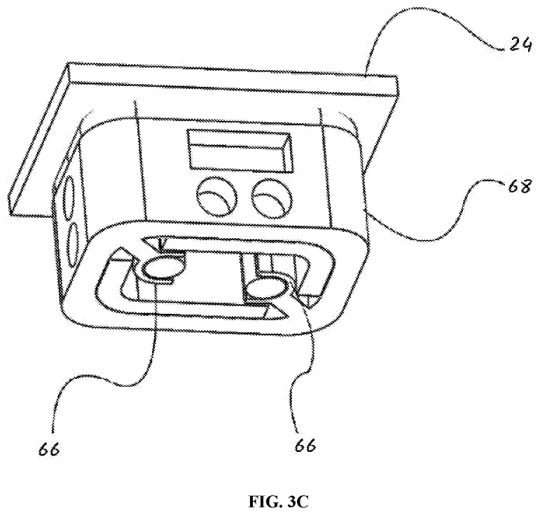

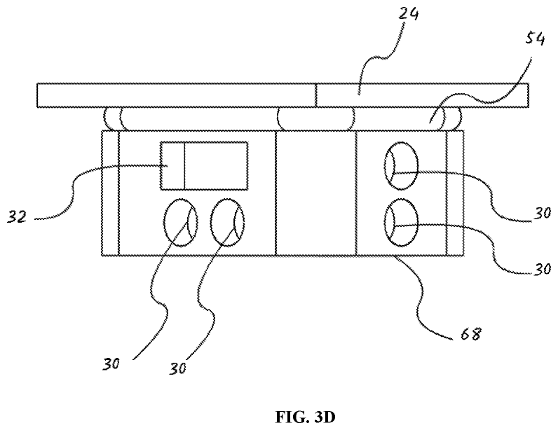

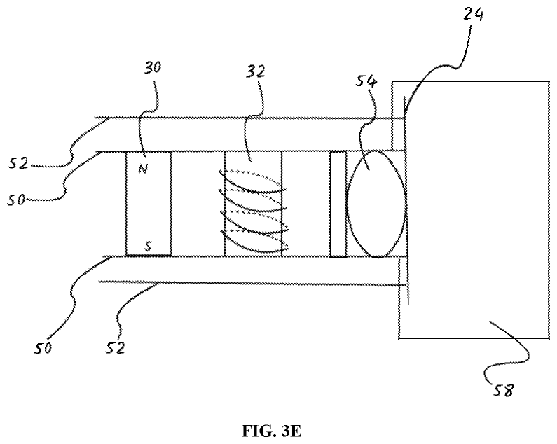

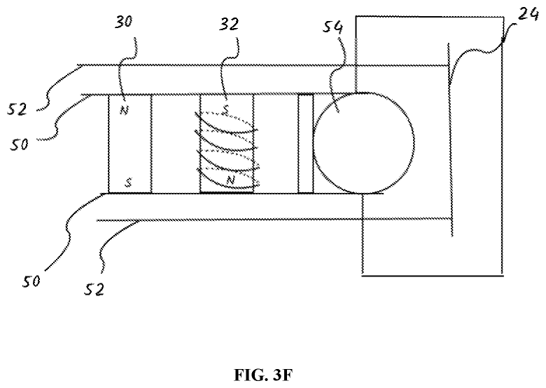

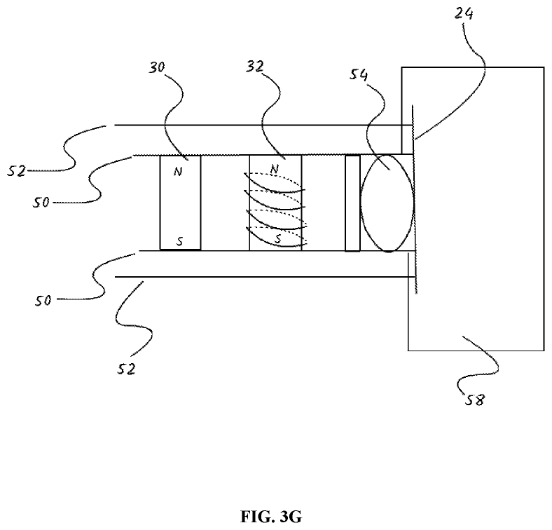

A similar embodiment including only a single moving valve member of high permeability magnetic material is illustrated in FIGS. 3A, 3B, 3C, 3D, 3E, 3F and 3G which discloses a fast-acting one-way valve for pre-stored vacuum/compressed air. The invention is a very fast acting valve that works in microseconds. The valve is a one-way valve releasing stored vacuum/compressed air.

FIG. 3A illustrates the valve body 68 and the vacuum chamber 58.

FIGS. 3B, 3C and 3D illustrate details of valve parts.

The valve consists of moving valve member 24 of high magnetic permeability connected to 2 guide rods 28, moving up and down in channels 66. The valve body 68 is a 4 sided rectangular cylinder with a non-magnetic material, with 2 holes cut on each side for permanent magnets 30 and 2 rectangular slots cut on the 2 longer sides of the rectangular valve for low permeability electromagnets 32. The valve body 68 also has channels 66 for the guide rods 28. Compression member 54 is stuck to the valve body 68 between it and the moving valve member. Inner “L” shaped high magnetic permeability paths 50 are positioned inside the valve body. Outer “L” high magnetic permeability paths 52 are positioned outside the valve body. The function of both sets of high magnetic permeability paths 50 and 52 is to close the magnetic path of magnetic flux from the permanent magnets 30—either with the low permeability electromagnets 32, or with the moving valve member 24, as is explained below. Thus, essentially both sets of high magnetic permeability paths 50 and 52, preferably of high permeability steel have to have a higher permeability than the low permeability electromagnets 32, which are preferably of lower permeability material such as powdered iron. Additionally, both sets of high magnetic permeability paths 50 and 52, which extend above the valve body 68, also serve as enclosures for the compression member 54 which is fixed to the top of the valve body 68. This not only secures the compression member 54, but prevents sideward squashing of compression member 54 on closure of valve against valve seat, increasing potential energy of compression stored in compression member 54 by valve closure, helping it pushes the moving valve member 24 during valve opening, and also prevents any air leaks through the valve.

The valve has 4 operating conditions: Firstly, closed: A closed condition, where all magnetic flux from permanent magnets 30 is going through the high magnetic permeability paths 50 and 52 and moving valve member 24 because they have higher permeability than low permeability electromagnets 32. Secondly, opening: To open the valve, give a short pulse to low permeability electromagnets 32, such that their polarity is opposite to that of the permanent magnets 30. Both, the permanent magnets 30 and low permeability electromagnets 32 will now loop the path of the magnetic flux through each other, leaving the moving valve member 24 to burst open. This bursting open is further aided by 2 other factors—the compressed compression member 54 also pushes the moving valve member 24 open and the vacuum generated in the vacuum chamber 58 simultaneously pulls the moving valve member 24 open. Thirdly, open: All flux from the permanent magnets 30 is choosing the magnetic path through unpowered low permeability electromagnets 32 via high magnetic permeability paths 50 and 52, as it is a shorter magnetic path. Fourthly, closing: To close the valve again, a reverse pulse is given to the low permeability electromagnets 32—the magnetic flux from the permanent magnets 30 now stops looping through the low permeability electromagnets 32, instead, as both become the same polarity, together both pull the moving valve member 24 to shut the valve, closing the magnetic path through the high magnetic permeability paths 50 and 52 and the moving valve member 24. The valve closure may be aided by a spring in some embodiments.

This valve may be used with compressed air pushing the moving valve member 24 open, rather than the vacuum pulling the valve open as in this embodiment.

FIG. 3E illustrates a schematic view of the valve of this embodiment which demonstrates the valve in closed position, where the electromagnet is switched off, the moving valve member 24 is pressed shut against high magnetic permeability paths 50 and 52 and the compression member 54 is squeezed.

FIG. 3F illustrates a schematic view of the valve of this embodiment which demonstrates the valve in open position, where the low permeability electromagnet 32 is in opposite polarity to permanent magnet 30, diverting the flux of permanent magnet 30 towards it, the moving valve member 24 is pushed away from high magnetic permeability paths 50 and 52, into vacuum chamber 58, the compression member 54 is expanded to its neutral condition.

FIG. 3G illustrates a schematic view of the valve of this embodiment which demonstrates the valve in closing position, where the low permeability electromagnet 32 has the same polarity as the permanent magnet 30, and both together hold the moving valve member 24 pressed to high magnetic permeability paths 50 and 52, to close the valve, squeezing the compression member 54.

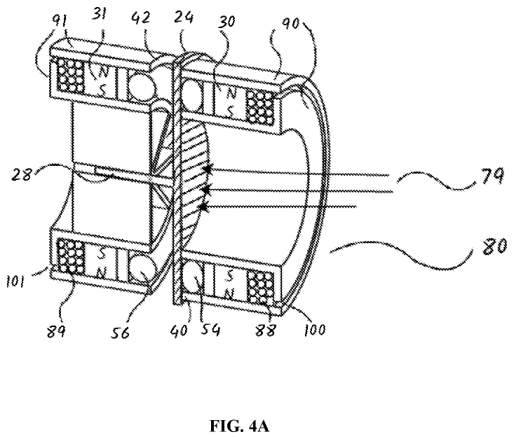

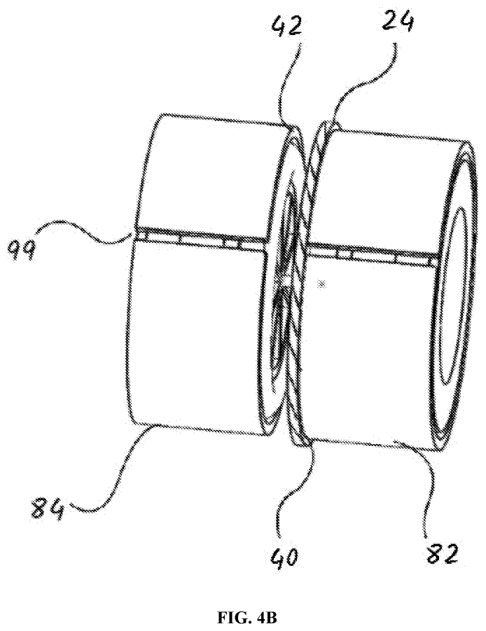

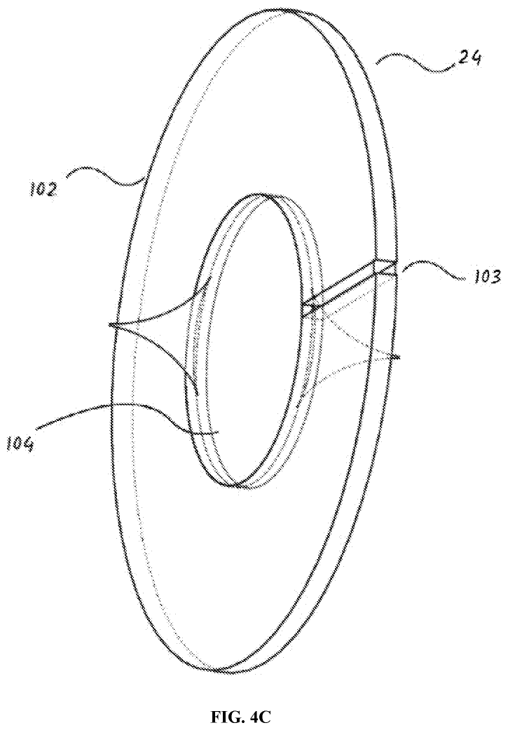

Another embodiment of a one-way valve is illustrated in FIGS. 4A and 4B. FIG. 4A illustrates the cross-section and FIG. 4B illustrates a perspective view of this embodiment. In this embodiment of valve 80, there are two valve seats 40 and 42, one moving valve member 24 with guide rod 28, two compression members 54 and 56 and two latches 82 and 84. The first and second latches 82 and 84 are magnetic, comprising permanent magnets 30 and 31 respectively, a coil 88 and 89 respectively and ferromagnetic material 90 and 91 respectively. In this case, there is a small gap 100 and 101 in the portion of the ferromagnetic material 90 and 91 respectively behind the coil. This gap makes the portion of the ferromagnetic material on the coil side of the permanent magnets 30 and 31 act as a low permeability core, as in the previous embodiment.

The valve functions in four steps, as explained below.

Firstly, closed: Moving valve member 24 is held against the first valve seat 40 by the permanent magnet 30 of the first latch 82, with its flux closing a magnetic circuit via the ferromagnetic material 90 and the moving valve member 24. Secondly, opening: To open the valve, the coil 88 of the first latch 82 is momentarily activated via a short pulse, such that it diverts the flux of the permanent magnet 30 of the first latch 82 to the portion of ferromagnetic material 90 behind coil 88 of the first latch 82, passing through the gap 100, letting go of the moving valve member 24, which then bursts open along the direction of the flow shown by arrows 79, further aided by the decompression of the first compression member 54 and the pressure of the fluid moving forwards, towards the second valve seat 42, to abut against it. Thirdly, open: Simultaneously, a short pulse is given to coil 89, such that it adds to the flux of permanent magnet 31 of the second latch 84 helping attract the moving valve member 24 by flux passing through the ferromagnetic material 91, closing the magnetic circuit via the moving valve member 24, holding it against the second valve seat 42, compressing the second compression member 56. Fourthly, closing: To release the moving valve member 24 to once again close the valve, the electromagnet 89 of the second latch 84 is provided with a reverse pulse such that the flux of the permanent magnet 31 of the second latch 84 is diverted to close its magnetic circuit through the ferromagnetic material 91 behind the coil 89 instead of through the moving valve member 24, passing through the small gap 101, releasing the moving valve member 24. This is further aided by the decompression of the second compression member 56 to move towards and abut against the first valve seat 40 to close the valve. Simultaneously, the coil 88 is provided with a short pulse such that it adds to the flux of permanent magnet 30 of the first latch 82, to latch the moving valve member 24 to the first valve seat 40.

Preferably, the compression member 56 is made such that it may store more potential energy than compression member 54, to aid in the closure of the valve, as there is no air pressure to aid this closure unlike when the valve has to open.

In the current embodiment, the ferromagnetic material 90 and 91 are both in the shape of 2 concentric cylinders that may advantageously have a slot 99 right through the length of both sets of concentric cylinders, filled with a non-magnetic material, to eliminate the formation of eddy currents, allowing for ultra-fast actuation.

Even the moving valve member may preferably have a hole and slot filled with a non-magnetic material to prevent the formation of eddy currents. One such embodiment is illustrated in FIG. 4C, where moving valve member 24 is made up of magnetic washer 102, with a slot 103 in it. Slot 103 and a washer hole 104 are filled with a non-magnetic material, to help prevent the formation of eddy currents in moving valve member 24.

A third embodiment of the valve is a two-way valve which comprises a combination of two valves of the second embodiment in a particular configuration. For e.g. if two valves of the embodiment shown in FIGS. 4A and 4B are placed back to back, with their valve seats, compression members and magnetic latches facing away from each other, with their two moving valve members connected by their guiding rods to each other, such that each could alternately abut against its corresponding inner valve seat from outside the valve to close it, it would act as a bi-stable two-way valve of this third embodiment, instead of a one-way valve of the embodiment of FIGS. 4A and 4B. Optionally, the second magnetic latch on the outsides could be eliminated, keeping only an additional fixed compression member at a slight distance outside each valve seat, such that as one moving valve member would alternately compress first its inner compression member—which is shown in FIG. 4A as compression member 54 and then its outer compression member which is shown in FIG. 4A as compression member 56, while simultaneously, the other moving valve member would first compress its outer compression member and then its inner compression member, both moving valve members using the stored potential energy of their two sets of compression members to aid their ultra-fast back and forth movement, for very fast valve actuation. This embodiment could easily be used as a 5/2 valve or a 4/2 valve.

The bursting open of the valve may be independent of the fluid pressures. For example, in the above embodiment, this can be achieved by keeping the four compression members of higher compressibility. The force of the compression members may be increased and springs could also be added to increase this force. Compensation is to be made for heat expansion and pressure elongation of guide-rods. The compression members may additionally have thixotropic or rheopectic fluids to aid in the absorption of shock and allow for a soft landing of the moving valve member against the valve seat.

A single 5/2 valve of the above embodiment may be modified to form a 2/2 valve by blocking one output and keeping the rest same. In this case, the 2 vacuum ports get connected as exhaust and each time a little fluid is wasted as it has to be exhausted out.

A valve and an actuator of another embodiment comprises: two moving valve members; two valve seats; two compression members; two latches; two exit ports and one port for entry of fluid into valve, such that opening of one exit port by unlatching of the first latch, enabling movement of the first moving valve member along the direction of fluid flow simultaneously brings the second moving valve member to abut against the second valve seat where it is latched by the second latch, closing the other exit port and vice-versa in the next cycle, acting like a 3 port, 2 position valve, which may be used as an ultra-fast bistable linear actuator.

A valve and actuator of yet another embodiment comprises: one moving valve member; one valve seat; one compression member; one latch; one spring member; one inlet port; and one outlet port; such that the opening of the port by unlatching of the latch enables the movement of the moving valve member along the direction of fluid flow such that it simultaneously stores energy in the spring member such that the release of this energy stored in the spring member causes the return of the moving valve member to close the valve, abutting against the compression member and valve seat, acting like a 2 position valve, which may be used as an ultra-fast bistable linear actuator.

The same functional principles shown in the above embodiments are utilized in different configurations to produce valves of the 5/2, 4/2, 3/2, 2/2, 5/3, 4/3 type or any other type. For e.g, two 5/2 valves of this invention or any other combination could be configured to work as a 5/3 valve, allowing for a whole range of ultra-fast valves and ultra-fast actuator.

In some embodiments, a reversal of magnetism of the latch attracting the moving valve member back away from the valve seat, just as the moving valve member is about to touch the valve seat, and softening the impact of the moving valve member on the valve seat. The reversal of magentism is being of too small a duration, and applied too late to actually pull the moving valve member away from the valve seat, merely aiding in reducing impact of moving valve member on valve seat. This doesnt hinder the ultra-fast opening of the valve, yet protects the valve seats from impact.

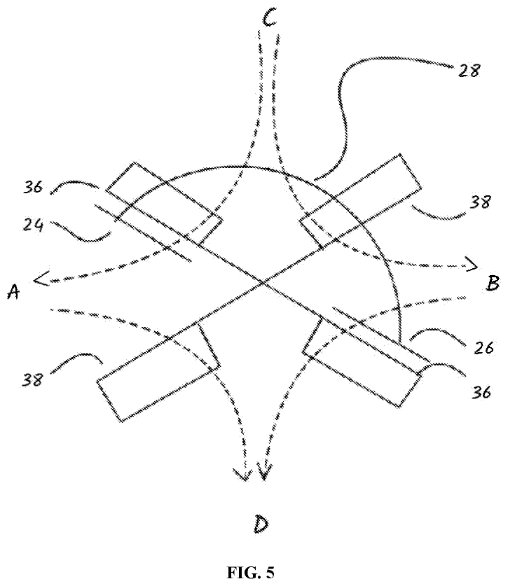

Another embodiment of a 4/2 valve of this invention is a rotary valve as shown in FIG. 5. Moving valve members 24 and 26, connected by guide rod 28, pivot around its center, together alternately close valve openings 36 and 38. The arrows indicate the direction of fluid flow in this valve. Such a rotary valve requires even less energy to actuate than the linear valves of the earlier embodiments, as the moving valve members in the case of a rotary valve of this invention have to pivot along one side of the valve seat to open the valve, unlike the linear valves of this embodiment, where the entire moving valve member has to be lifted off to open the valve, requiring more energy. Further, the flow of fluid out of the valve is much faster in the rotary valve as part of the valve opens immediately, even as the rest of the moving magnet member is being lifted off the valve seat.

To further aid the ultra-fast opening of the valve, in some embodiments, an actuator like voice coil, solenoid, moving magnet, etc. could be attached to the moving valve member. This actuator would be activated as soon as the moving valve member is unlatched, actively opening the valve in addition to the fluid pressure and the decompression of the compressed compression member pushing the moving valve member forwards, to burst open the valve at very high speeds. This additional active actuation would require very little additional power, as the moving valve member is already being pushed open in the direction of the fluid flow by unlatching of the latch, along with the forward movement of the fluid out of the valve and the decompression of the compression member present at that valve seat. Even in embodiments with two moving valve members connected to each other with a guide-rod, additional actuation can be provided to the moving valve members by such an additional actuator like a solenoid, voice coil or moving magnet connected to the combined structure of two connected moving valve members.

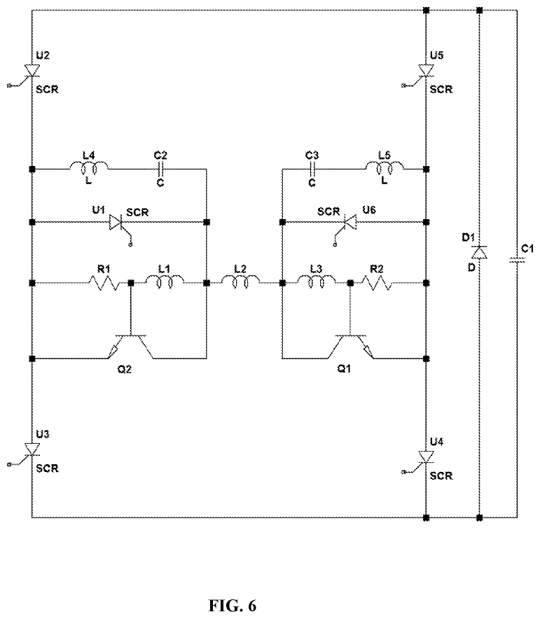

In another embodiment, the control circuitry for the valve may be fine-tuned to further increase the speed of valve actuation as shown in FIG. 6. For highest speeds, a high voltage is better and to control the pulse, a capacitive discharge method is easier as it allows for very high voltage pulse, very high current, very short pulse duration—so actually very thin wire can be used for winding, and just a few turns. Since one side is latched, it needs to be unlatched, the moving valve member has to move, and it needs to be latched to the second latch. The unlatching and movement of the moving valve member can be done together to allow ever faster actuation of the valve. Here the actuator is preferably a constant force actuator like a voice coil or a constant force solenoid. Such a constant force actuator can start an exponentially fast movement if given a high voltage pulse. Coil L1 of the 1^{st} latch, coil L2 of the actuator, and coil L3 of the 2^{nd} latch are connected is series and fed a high voltage of 300-1000 volts from a charged capacitor C1 via an “H-bridge” SCR U2, U3, U4 and U5 to allow bistable operation of the valve. There is a flyback diode D1 in the circuit and there are also 2 bypasses on each of the latch coils—one is a current control bypass Q1 and Q2 and the other is a short circuit bypass U1 and U6. When one side of the H-bridge U2 and U4 is switched on, the short-circuit bypass U1 on first latching coil L1 is bypassed; the current rises rapidly in the unlatching coil L3 of the second latch and the actuator coil L2, till it reaches the current required for unlatching the moving valve member from the first latch. Then the current bypass Q1 of unlatching coil L3 of 2^{nd} latch comes on and keeps the current under control in the unlatching coil L3, while increasing the current in the actuator coil L2 exponentially—which causes rapid movement of the moving valve member to the other side, and when it reaches the second latching side, yet without enough power to compress the rubber seal which also acts as the compression member, the capacitor C1 is nearly drained, but the inductive flyback continues the current sufficient to power the latch coil L1 and energizes the first latch, and short circuit bypass U1 goes off because of commutation by L4 and C2—which is correct time when the first latch needs to be energized, pulling the moving valve member towards the first latch, latching it securely.

The energy stored in a capacitor is ½ capacitance*voltage², so the higher the voltage, the more is the energy that is stored in the capacitor, so smaller capacitor can be used. Unlatching the magnetic latch needs only a small current after which it begins to reverse latch again, which is of no use, so keeping that at a fixed current while shifting over, is essential. Also, the linear actuator has to operate and has to consume the bulk of the voltage to quickly shift the valve member to the opposite side. Since the constant force actuator of this embodiment gets the exponential capacitor pulse, it acts exponentially with the highest force in the beginning, and peters off gradually, as is needed. Whereas a solenoid in its place would act reverse, which is opposite what is needed—hence a voice coil or a constant force solenoid is the preferred linear actuator.

Normally, valves are operated by solenoids, which have opposite exponential increases in power—they start very slow and when they need the power they have no force and the force keeps building up and when it reaches the other side and it needs to stop, there is an exponentially huge force. What is needed was a maximum force in the beginning to overcome the inertia. To circumvent the problem, solenoids have a very short stroke. They utilize the very high power and have the smallest possible valve orifices. The moving part is kept as light as possible. For better sealing, they open against the force of the fluid, so they close faster but open slowly, where they were needed to be fast, again this is wrong. When they need to stop, the solenoids are actually at highest acceleration. Eddy currents in the magnetic circuits as an inductive load slow down the rise of current and solenoid plungers are typically high inductive loads. Principally all this is wrong and does not allow for high-speed valves.

So what is needed is a solution (valve and actuator) that solves all these problems. For a high-speed valve and actuator, maximum force is needed at the beginning of the stroke. Various embodiments of this invention provide such solutions. To open the valve along the air flow such that it bursts open as in this invention is very non-intuitive. To prevent such a valve from leaking/bursting when needed to be closed, a latch is used—magnetic/otherwise. To unlatch it, and then to move it fast like a motor/voice coil, not like a solenoid—exponential movement by using a capacitor to a voice coil or a constant force solenoid or any other constant force actuating means. When the moving valve member reaches the other side, some embodiments of this invention latch it on the other side if it is required to be bistable. In other embodiments for sorting applications—bistable valve is not required—they just need a small air pulse, with the valve opening for a short time allowing just a small air jet to be expelled from the valve and the moving valve member is brought back with an actuator, preferably a voice coil/any other constant force actuator and latched again. For jet valves, where the moving valve member is required to come back and be latched, some embodiments of this invention use magnetic and electrical inductive-capacitive (LC) resonance or a spring to add to its return and latch it.

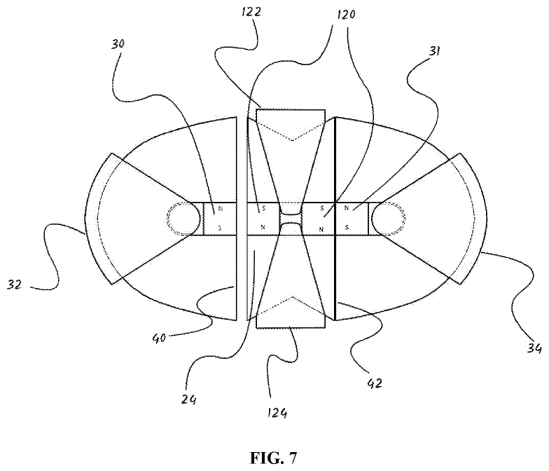

In another embodiment of the valve, as illustrated in FIG. 7, the moving valve member 24 has additionally, electromagnets 122 and 124 and permanent magnets 120, which are in opposite polarity to the permanent magnets 30 and 31. Electromagnets 32 and 34 are either energized or off, to attract the moving valve member or to stop attracting it respectively. When energized, the electromagnets 32 and 34 are always energized in the same polarity as the permanent magnets 30 and 31 respectively, and add on to the attractive force of permanent magnets 30 and 31 towards moving valve member 24. To attract the moving valve member 24 towards valve seat 42, the electromagnet 34 is energized, adding to the attractive force of permanent magnet 31. At the same time, electromagnet 32 is switched off, to stop attracting the moving valve member 24 and allow it to move towards valve seat 42. Also, the electromagnets 122 and 124 are so energized so as to facilitate movement of magnetic flux from permanent magnets 120 through electromagnets 122 and 124 to close a magnetic circuit through electromagnet 34 and permanent magnet 31, thus pulling the moving valve member 24 towards valve seat 42 and latching it there. To unlatch the moving valve member 24 from valve seat 42, the electromagnet 34 is switched off. Simultaneously, the electromagnet 32 is switched on, and the polarity of both electromagnets 122 and 124 is reversed so as to allow magnetic flux from permanent magnets 120 to move through the electromagnets 122 and 124 via electromagnet 32 and permanent magnet 30 to close the magnetic circuit and pull and latch the moving valve member 24 to valve seat 40.

In the foregoing specification, specific embodiments of the present invention have been described. However, one of ordinary skill in the art will appreciate that various modifications and changes can be made without departing from the spirit and scope of the present invention as set forth in the various embodiments discussed above and the claims that follow. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

I claim:

1. A valve unit comprising:
a moving valve member that enables the opening and closing of the valve;
a valve seat; and
a latch comprising of a permanent magnet, and an electromagnet
wherein, the valve is shut against the direction of the fluid flow by the latch by holding the moving valve member against the valve seat and when a high power pulse is provided to the electromagnet, the moving valve member moves forward along the direction of fluid flow for opening the valve in few microseconds with its forward movement

2. The valve unit as claimed in claim 1 comprising additionally:
a compression member for shock absorption and to aid valve opening, wherein when the latch holds the valve shut against the direction of fluid flow by abutting the moving valve member against the valve seat it simultaneously compresses the compression member, and when the moving valve member is unlatched, the compressed compression member decompresses and pushes the moving valve member that was compressed against it forward, which, along with the pressure of the fluid, adds up to accelerate the opening of the valve along the direction of fluid flow.

3. The valve unit as claimed in claim 2 comprising additionally:
thixotropic or rheopectic fluids to aid in absorption of shock and enables a soft landing of the moving valve member against the valve seat.

4. The valve unit as claimed in claim 1, wherein a reversal of magnetism of the latch attracting the moving valve member back away from the valve seat, just as the moving valve member is about to touch the valve seat, and softening the impact of the moving valve member on the valve seat, wherein said reversal of magnetism is being of small duration.

5. The valve unit as claimed in claim 1 is configured such as to form:
a monostable valve with only one valve unit; and
a bistable valve comprising either one of:
two valve units which are faced opposite to each other with a common moving valve member alternating between them; or
two valve units which are placed facing opposite to each other in one valve housing, such that the two moving valve members of the two valve units are connected to each other by a connector; and
a 4/2 valve that is made with four valve units of claim 1 and is configured as two pairs opposite to each other, with two connected moving valve members in between, rotating about a central point, and alternately closing diagonally opposite valve units.

6. The valve unit as claimed in claim 1, comprising additionally an actuator that is connected to the moving valve member, wherein the actuator operates to aid in the faster movement of the moving valve member.

7. The valve unit as claimed in claim 1, wherein the moving valve member is made of high permeability soft magnetic material and the latch further comprises:
a soft magnetic component with permeability more than that of the electromagnet in suitable configuration,
wherein the soft magnetic component completes a magnetic circuit with the moving valve member, and through the permanent magnet when the moving valve member is held against the valve seat, and wherein the combination of the permanent magnet and the electromagnet is placed with their poles touching the soft magnetic component such that when the electromagnet is provided with a short pulse to energize it momentarily in reverse polarity to the permanent magnet, the electromagnet diverts the magnetic flux from the permanent magnet along the soft magnetic component towards the electromagnet, thereby unlatching the moving valve member, and shuttling the valve open in the direction of the fluid flow, wherein when the polarity of the electromagnet is reversed and the magnetic flux of the permanent magnet and the electromagnet flows preferably through the higher magnetic permeability material of the moving valve member, attracting the moving valve member, to abut against the valve seat and to shut and latch the valve.

8. The valve unit as claimed in claim 1, configured to form a bistable valve comprising additionally, a second valve unit of claim 1, wherein the two valve units face each other with a common moving valve member or alternately latching to the valve seat of each valve unit, wherein the latches of both valve units comprise a ferromagnetic component;
arranged such that the moving valve member is held against the first valve seat by the permanent magnet of the first latch, with its flux closing a magnetic circuit through the ferromagnetic component and the moving valve member, wherein when the electromagnet of the first latch is activated, the flux of the permanent magnet of the first latch is diverted to the electromagnet of the first latch, through a small air-gap of the magnetic circuit, which enables the movement of the moving valve member, which then rapidly opens along the direction of the flow, further aided by the pressure of the fluid moving forwards, pushing the moving valve member towards the second valve seat, wherein the permanent magnet of the second latch attracts the moving valve member by passing the flux through the ferromagnetic component, closing the magnetic circuit through the moving valve member, and holding the moving valve member against the second valve seat, to release the moving valve member to once again to close the valve, wherein when the electromagnet of the second latch is activated the flux of the permanent magnet of the second latch to close its magnetic circuit through the electromagnet instead of through the moving valve member, and releasing the moving valve member to move towards the first valve seat to close the valve, where it is latched by the permanent magnet of the first latch, whose electromagnet is reversed to have the same polarity as the permanent magnet, to help it latch the moving valve member.

9. The valve unit as claimed in claim 1, comprising additionally varying fluidic pressures on both sides of the moving valve member, wherein when the latch unlatches the moving valve member, the changed fluid pressure further opens the valve in the direction of fluid flow.

10. The valve unit as claimed in claim 6 configured to form a bistable valve, comprising additionally a second valve unit of claim 4; wherein said two valve units face each other with a common moving valve member, which is actuated by giving a sudden high voltage pulse to instantly unlatch the moving valve member, from the first valve unit, and to simultaneously power the actuator exponentially for ultrafast movement of the moving valve member and after suitable time, wherein when the moving valve member reaches the second valve unit, the fly-back of the latch and the actuator of the first valve unit and the remainder of the high voltage pulse latches the moving valve member to the second valve unit.

11. The valve unit as claimed in claim 6 configured to form a monostable high-efficiency jet valve, comprising additionally a magnetic and electrical inductive-capacitive (LC) resonance circuit to aid the moving valve member to return to the valve seat after releasing a jet of air and be latched.

12. The valve unit as claimed in claim 1 configured as a high-speed actuator, comprising additionally: a compressed air source.
